(19) United States
(12) Patent Application Publication
(10) Pub. No.: US 2026/0274120 A1
(43) Pub. Date: Sep. 17, 2026

(54) SEATBACK LOCK DEVICE AND VEHICLE SEAT

(71) Applicants: NHK SPRING CO., LTD., Yokohama-shi (JP); SUBARU CORPORATION, Tokyo (JP)

(72) Inventors: Jun AOKI, Yokohama-shi (JP); Tomoya TAKAHASHI, Yokohama-shi (JP); Yosuke ISHIYAMA, Tokyo (JP); Taiki ONO, Tokyo (JP)

(21) Appl. No.: 19/567,679

(22) Filed: Mar. 16, 2026

(30) Foreign Application Priority Data
Mar. 17, 2025 (JP) 2025-042957

(51) Int. Cl. B60N 2/22; B60N 2/433

(52) U.S. Cl. CPC B60N 2/2245; B60N 2/433

(57) ABSTRACT

In a seatback lock device, a lever bracket is coupled to a lock main body that is coupled to a side portion of a frame of a seatback. A strap and an inner wire of a remote cable are coupled to the lever bracket. The lever bracket covers a protection member from a seat front side. This protection member includes a wire member fixed to the side portion of the seatback frame, and a plate member fixed to the wire member.

### CROSS-REFERENCE TO RELATED APPLICATION

This application is based on and claims priority under 35 USC 119 from Japanese Patent Application No. 2025-042957 filed on Mar. 17, 2025, the disclosure of which is incorporated by reference herein.

### BACKGROUND

### Technical Field

The present disclosure relates to a vehicle seat, and in particular relates to a seatback lock device.

### Related Art

In a vehicle seat disclosed in Japanese Patent Application Laid-Open (JP-A) No. 2024-51098, a lock main body of a lock device provided at a side portion of a seatback engages with a striker coupled to a side portion of a vehicle body. An operation member for releasing locking by being pulled upward is coupled to the lock main body, and a strap for pulling the operation member upward is coupled to the operation member.

### SUMMARY

A vehicle seat such as this is, in addition to the strap for releasing locking of the lock main body, also equipped with a remote cable for releasing locking of the lock main body by remote operation. In such aa vehicle seat, for example, both the strap and the remote cable are coupled to a lever that has been coupled to the lock main body. External input from the seat front side is sometimes imparted to such a lever through a pad of the seatback during a vehicle collision. As a result thereof, there is a concern that the lever might be lifted up, and unwanted release of the locking of the lock main body might occur.

An object of the present disclosure is to obtain a seatback lock device and a vehicle seat that are able to prevent unwanted release of the locking of a lock main body provided at a seatback side portion by external input during a vehicle collision.

A seatback lock device of a first aspect of the present disclosure includes a lock main body that is coupled to a side portion of a frame of a seatback, so as to be tiltable in a forward direction with respect to a floor section of a vehicle body, and that engages with a striker provided at a side portion of the vehicle body, a lever that is arranged at a seat width direction inner side with respect to the lock main body and coupled to the lock main body, and that releases engagement between the lock main body and the striker by being displaced toward a seat upper side, a strap that is coupled to the lever and that displaces the lever toward the seat upper side by being pulled, a remote cable having a one-end portion of an outer casing thereof fixed to the side portion of the frame, and having an inner wire extending from the one-end portion coupled to the lever, the remote cable displacing the lever toward the seat upper side due to the inner wire being pulled, and a protection member that includes a wire member fixed to the side portion of the frame of the frame and a plate member fixed to the wire member, and that covers the lever from a seat front side.

In the seatback lock device of the first aspect, the lock main body is coupled to the side portion of the frame of the seatback coupled so as to be tiltable in a forward direction with respect to the floor section of the vehicle body, and engages with the striker provided at the vehicle body side portion. The lever arranged at the seat width direction inner side with respect to the lock main body is coupled to the lock main body, and releases engagement between the lock main body and the striker by being displaced to the seat upper side. The strap and the inner wire of the remote cable are coupled to the lever. The strap displaces the lever to the seat upper side by being pulled. The remote cable displaces the lever to the seat upper side due to the inner wire being pulled by remote operation while the one-end portion of the outer casing is supported by the side portion of the frame. The lever is covered by the protection member from the seat front side. Unwanted release of the locking of the lock main body can accordingly be prevented due to being able to prevent the lever from being lifted up due to external input from the seat front side during a vehicle collision. Moreover, a simpler and lighter configuration can be achieved for this protection member due to the protection member including the wire member fixed to the side portion of the frame, and the plate member fixed to the wire member.

A seatback lock device of a second aspect, is the first aspect, further including an abutting member that is fixed to the side portion of the frame and faces the protection member from a seat rear side.

In the seatback lock device of the second aspect, the abutting member that is fixed to the side portion of the seatback frame faces the protection member from the seat rear side. The protection member can be supported by the abutting member when external input has been imparted to the protection member from the seat front side during a vehicle collision.

A seatback lock device of a third aspect is the second aspect, wherein the abutting member is a cable fixing bracket to which the one-end portion of the outer casing has been fixed.

In the seatback lock device of the third aspect, configuration can be simplified due to the cable fixing bracket to which the one-end portion of the outer casing has been fixed also serving as the abutting member.

A seatback lock device of a fourth aspect is the third aspect, wherein the cable fixing bracket has an L-shaped cross-section open toward the seat width direction inner side and the seat upper side when viewed from the seat front side.

In the seatback lock device of the fourth aspect, the cable fixing bracket has the L-shaped cross-section described above, and so good strength of the cable fixing bracket can be secured against an external input from the seat front side.

A seatback lock device of a fifth aspect is any one aspect of the second aspect to the fourth aspect, further including an abutting wire that is fixed to the side portion of the frame separately from the abutting member, and that faces the protection member from the seat rear side.

In the seatback lock device of the fifth aspect, the abutting wire that is fixed to the side portion of the frame separately from the abutting member faces the protection member from the seat rear side. This enables the protection member to be supported by both the abutting member and the abutting wire when an external input has been imparted to the protection member from the seat front side during a vehicle collision.

A seatback lock device of a sixth aspect is any one aspect from out of the second aspect to the fifth aspect, wherein a gap is provided between the protection member and the abutting member.

In the seatback lock device of the sixth aspect, the gap is provided between the protection member and the abutting member, and so abnormal noises from unwanted contact between the protection member and the abutting member can be prevented from occurring.

A seatback lock device of a seventh aspect is the seatback lock device of the fifth aspect, wherein a gap is provided between the protection member and the abutting wire.

In the seatback lock device of the seventh aspect, the gap is provided between the protection member and the abutting wire, and so abnormal noises from unwanted contact between the protection member and the abutting wire can be prevented from being generated.

A vehicle seat of an eighth aspect includes a seat cushion for an occupant of a vehicle to sit on, a seatback that is coupled so as to be swingable with respect to a vehicle body and that supports a back of the occupant, and the seatback lock device of any one aspect from out of the first aspect to the seventh aspect, wherein the lock main body is provided at a side portion of the seatback, and the strap has been inserted into a strap pull-out opening formed in a shoulder of the seatback.

In the vehicle seat of the eighth aspect, the back of an occupant seated on the seat cushion is supported by the seatback. The seatback is coupled so as to be swingable with respect to the vehicle body. The lock main body of the seatback lock device is provided at the seatback side portion, and the strap of the lock device is inserted through the strap pull-out opening formed to the shoulder of the seatback. The lock device is that of one aspect from out of the first aspect to the seventh aspect, and so the above advantageous effects are obtained.

As described above, the seatback lock device and vehicle seat according to the present disclosure enable unwanted release of the locking of the lock main body provided at a side portion of a seatback to be prevented from occurring due to external input during a vehicle collision.

### BRIEF DESCRIPTION OF THE DRAWINGS

Exemplary embodiments of the present invention will be described in detail based on the following figures, wherein:

FIG. 1 is a front view illustrating part of a vehicle seat according to an exemplary embodiment;

FIG. 2 is a front view illustrating a frame of a seatback and a lock device of a vehicle seat according to an exemplary embodiment;

FIG. 3 is a front view illustrating an enlargement of part of the configuration illustrated in FIG. 2;

FIG. 4 is a first perspective view illustrating an enlargement of part of the configuration illustrated in FIG. 2;

FIG. 5 is a second perspective view illustrating an enlargement of part of the configuration illustrated in FIG. 2;

FIG. 6 is a side view illustrating an enlargement of part of the configuration illustrated in FIG. 2;

FIG. 7 is a bottom view illustrating an enlargement of part of the configuration illustrated in FIG. 2;

FIG. 8 is a front view illustrating an enlargement of part of the configuration illustrated in FIG. 3;

FIG. 9 is a front view illustrating a lock main body, a lever bracket, and a strap of a lock device;

FIG. 10 is a first perspective view illustrating a wire member provided in a protection member of a lock device;

FIG. 11 is a second perspective view illustrating a wire member provided in a protection member of a lock device;

FIG. 12 is a first perspective view illustrating a plate member provided in a protection member of a lock device;

FIG. 13 is a second perspective view illustrating a plate member provided in a protection member of a lock device;

FIG. 14 is a perspective view illustrating a cable fixing bracket of a lock device; and

FIG. 15 is a perspective view illustrating an abutting wire of a lock device.

### DETAILED DESCRIPTION

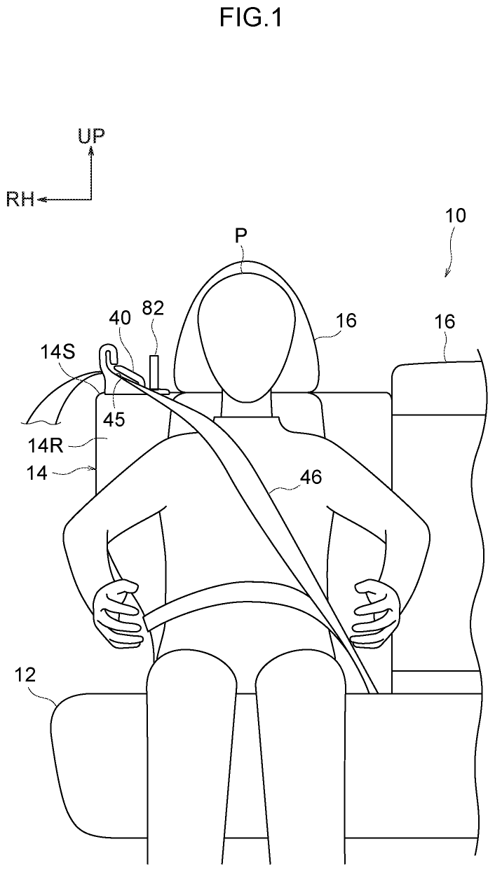

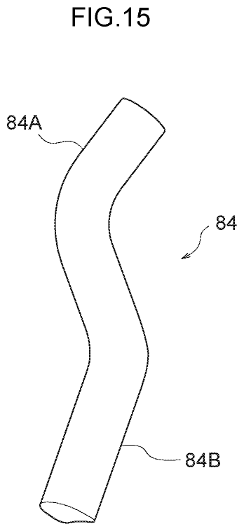

Description follows regarding a vehicle seat 10 according to an exemplary embodiment of the present disclosure, with reference to FIG. 1 to FIG. 15. Note that sometimes in the drawings reference numerals of parts are omitted in order increase readability of the drawings. Moreover, as appropriate in the drawings, the arrows FR, LH, RH, and UP respectively indicate forward, leftward, rightward, and upward directions of the vehicle seat 10. Hereinafter, when reference is simply given to front and rear, left and right, up and down in the following description then this indicates directions with respect to the vehicle seat 10.

As illustrated in FIG. 1, the vehicle seat 10 according to the present exemplary embodiment includes a seat cushion 12 for an occupant to sit on, a seatback 14 to support the back of the occupant, and a headrest 16 to support the head of the occupant. The vehicle seat 10 is, as an example, a three-person rear seat provided with respective headrests 16 at the left-right direction center and both left-right direction sides of an upper end section of the seatback 14 (the left headrest 16 is omitted in the drawings). The front and rear, left and right, and up and down directions of the vehicle seat 10 are aligned with the front and rear, left and right, and up and down directions of the vehicle.

The seatback 14 is divided into a right-side seatback 14R for two people, and a non-illustrated left-side seatback for one person. The right-side seatback 14R and the left-side seatback are each coupled so as to be swingable with respect to a floor section of a vehicle body through a non-illustrated hinge bracket and are configured so as to be tiltable in a forward over the seat cushion 12.

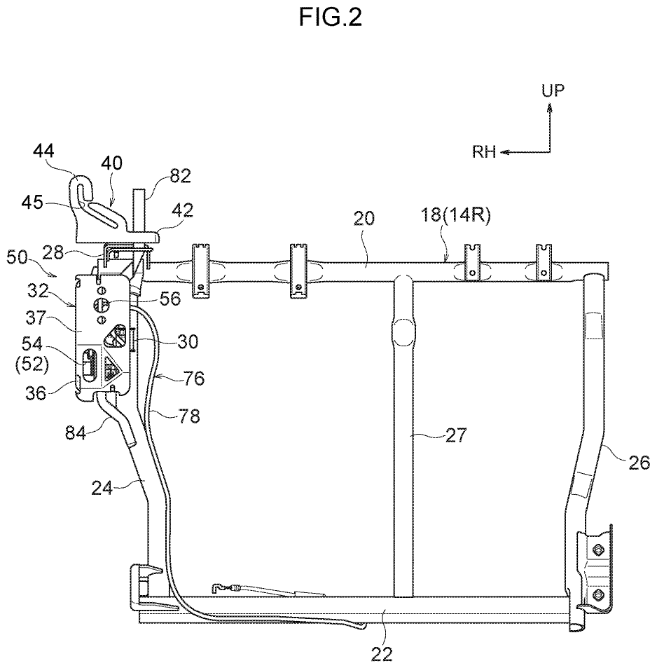

The right-side seatback 14R and the left-side seatback are each provided with a lock device 50 (see FIG. 2 to FIG. 9) to restrain the right-side seatback 14R and the left-side seatback in an upright position (the position illustrated in FIG. 1, hereafter referred to as “upright position”) to respective side portions of a non-illustrated vehicle body. Each of the lock devices 50 corresponds to a “seatback lock device” of the present disclosure.

Note that configuration in the vicinity of the lock devices 50 in the right-side seatback 14R and the left-side seatback is basically configured the same, other than being configured left-right symmetrical to each other, and so the configuration of the right-side seatback 14R will be described, with description of the configuration of the left-side seatback omitted. Moreover, reference below to front and rear, left and right, up and down directions indicate directions when the seatback 14R is positioned in the upright position.

The seatback 14R includes a frame 18 that is a framework member (see FIG. 2), a pad (reference numeral omitted) that is a cushion member, and a trim cover (reference numeral omitted) that is a covering. The frame 18 is, for example, configured as a frame shape by joining together metal pipe material and press-formed metal plate blanks. The pad is, for example, configured from a foam body of urethane foam or the like, and is coupled to the frame 18. The trim cover is, for example, formed in a bag shape by stitching together plural covering pieces of cloth material, leather, synthetic leather, or the like, and is covered over the seatback pad from the upper side thereof.

The frame 18 includes an upper frame section 20 that extends in the left-right direction at an upper end portion of the seatback 14R, a lower frame section 22 that extends in the left-right direction at a lower end portion of the seatback 14R, a right side frame section 24 that extends in the height direction at the right end of the seatback 14R, a left side frame section 26 that extends in the height direction at a left end of the seatback 14R, and an intermediate frame section 27 that extends in the height direction at a left-right direction intermediate portion of the seatback 14R.

As illustrated in FIG. 2, an upper bracket 28 configured from a press-formed metal plate blank is fixed to a right end portion of the upper frame section 20 of the frame 18. As illustrated in FIG. 2 to FIG. 8, a lock bracket 30 configured from a press-formed metal plate blank is fixed to an upper portion of the right side frame section 24.

A seatbelt guide 40 is fixed to an upper face of the upper bracket 28. The seatbelt guide 40 is, as illustrated in FIG. 1, provided at a shoulder 14S on the right side of the seatback 14R. The seatbelt guide 40 includes a base 42 fixed to the upper bracket 28 by a means such as bolt fastening or the like, and a belt guide portion 44 that extends upward from the base 42. A slit 45 for insertion of a three-point seatbelt 46 is formed in the belt guide portion 44.

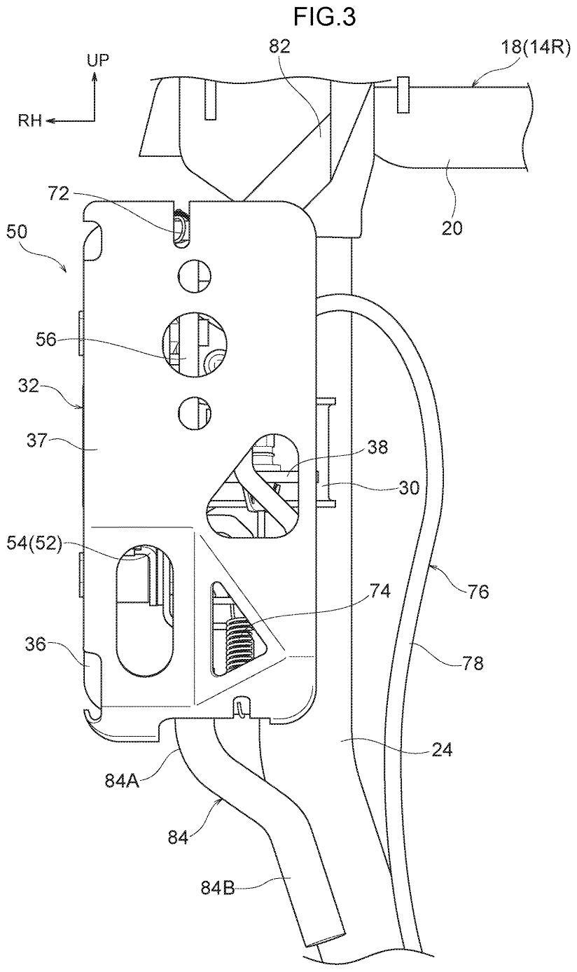

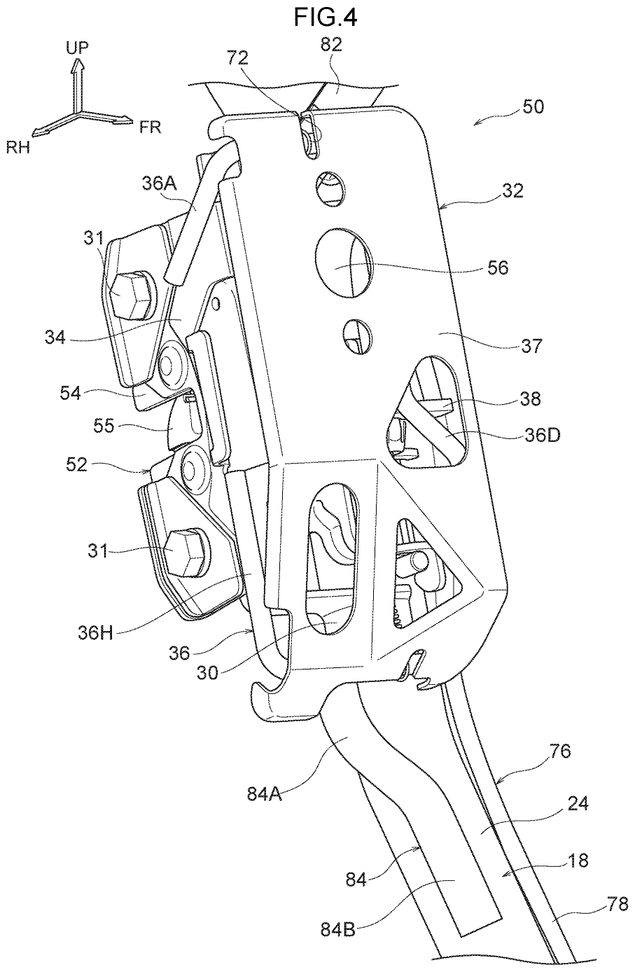

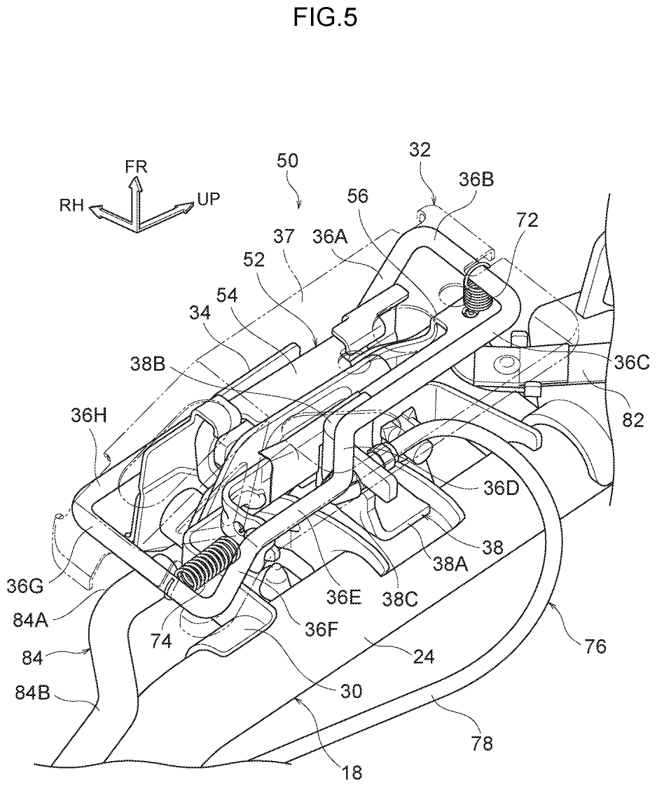

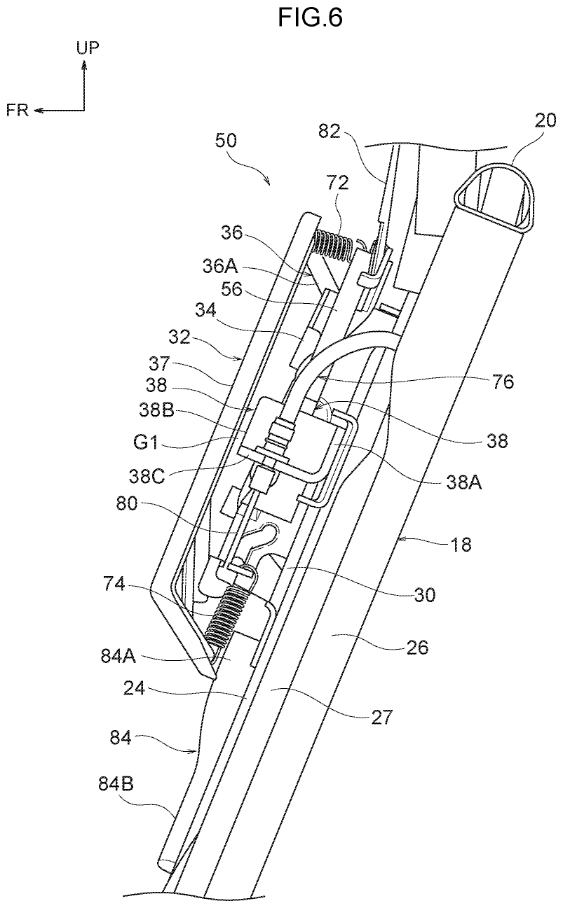

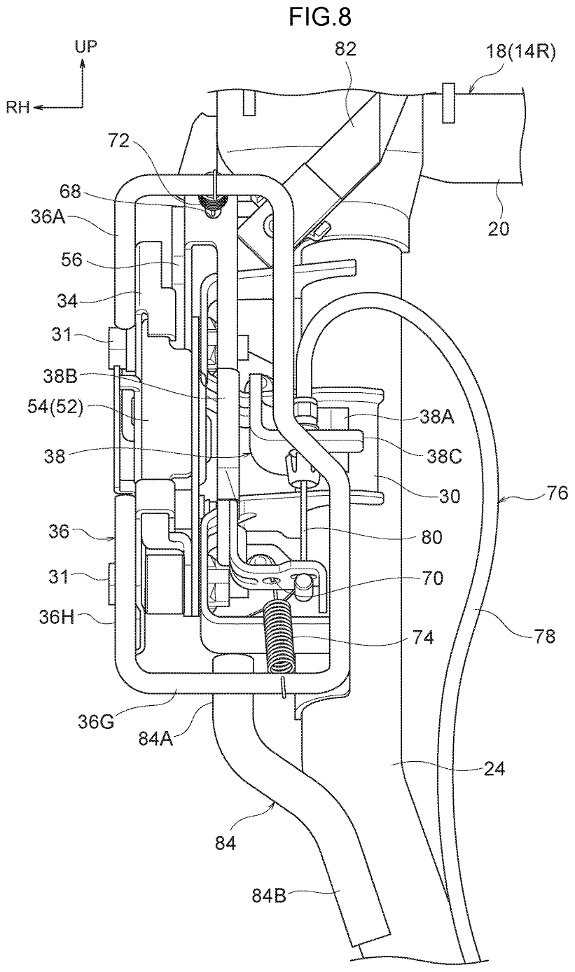

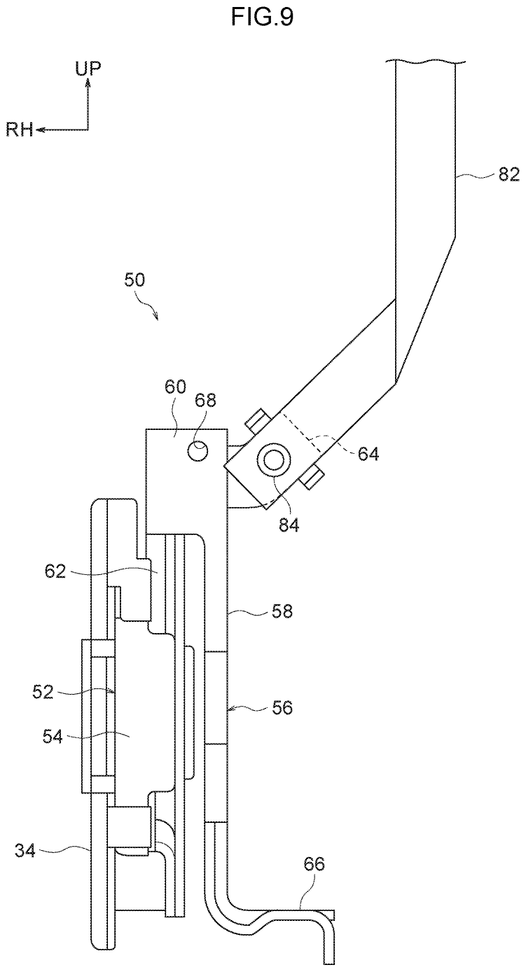

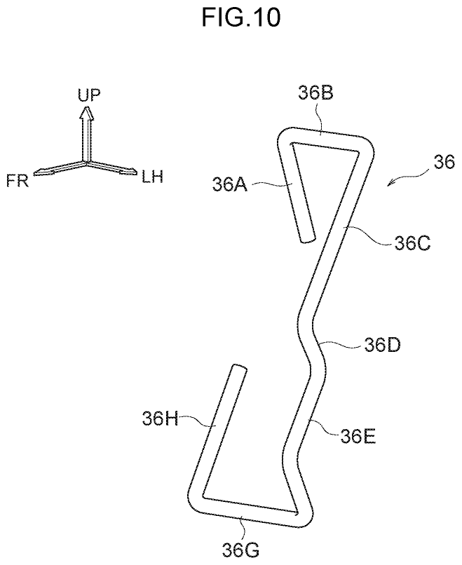

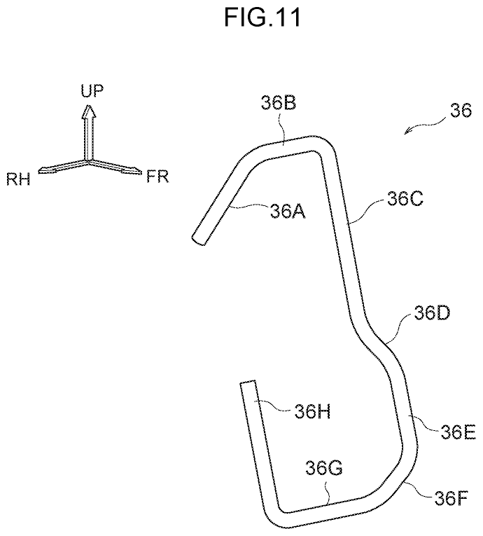

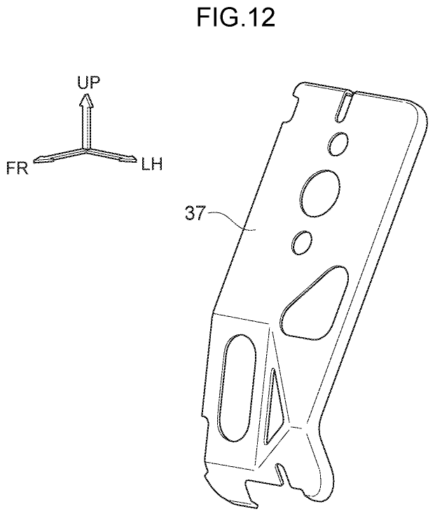

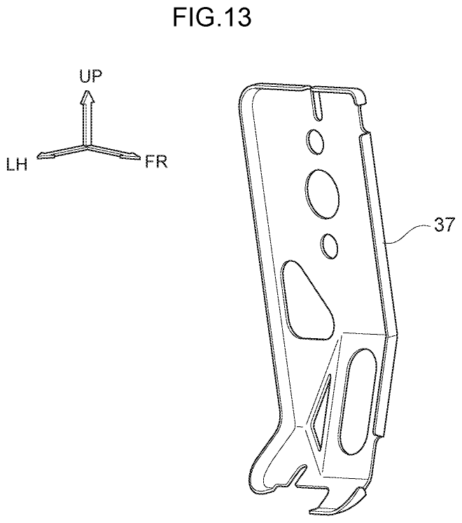

A lock main body 52 of the lock device 50, and a protection frame 32, serving as a protection member, are fixed to the lock bracket 30. As well as the lock main body 52 and the protection frame 32, the lock device 50 also includes a lever bracket 56 (see FIG. 5, FIG. 6, FIG. 8, and FIG. 9), and a strap 82 (see FIG. 1 to FIG. 6, FIG. 8, and FIG. 9). The protection frame 32 includes an attachment bracket 34 (see FIG. 4 to FIG. 9), a wire member 36 (see FIG. 3 to FIG. 8, FIG. 10 and FIG. 11), and a plate member 37 (see FIG. 2 to FIG. 7, FIG. 12, and FIG. 13).

As illustrated in FIG. 4 to FIG. 7, the lock main body 52 of the lock device 50 includes a housing 54 fixed to the lock bracket 30. The housing 54 is configured by coupling plural press-formed metal plate blanks together, and is formed in a substantially box shape that has a length direction along the height direction is and flattened in the left-right direction. The housing 54 is fixed to the lock bracket 30 by fastening using bolts 31.

Mechanism components, such as a latch 55 (see FIG. 4) for engaging with a non-illustrated striker provided at the vehicle body side portion, are housed inside the housing 54. Due to such engagement, the seatback 14R is restricted from swinging with respect to the vehicle body and is restrained in the upright position. The latch 55 is attached so as to be rotatable with respect to the housing 54. Configuration is such that the engagement between the striker and the latch 55 is released by the latch 55 being rotated to the seat upper side. Swing restriction of the seatback 14R is release by such engagement release, enabling the seatback 14R to tilt forward onto the seat cushion 12.

The latch 55 is indirectly coupled to the lever bracket 56, which is a lever (see FIG. 8 and FIG. 9). The lever bracket 56 is, for example, configured from a press-formed metal plate blank and is arranged at the left side (seat width direction inner side) with respect to the lock main body 52. The lever bracket 56 is configured from a lever main body 58 that extends in the height direction at a vicinity of the left side of the lock main body 52, an outside projection 60 that projects from a front edge of an upper end portion of the lever main body 58 toward the right side (seat width direction outer side) and that is bend toward the rear side, a lock coupling portion 62 that extends downward from a leading end portion of the outside projection 60, a strap coupling portion 64 that extends diagonally toward the left side and the upper side from a rear edge portion of an upper end portion of the lever main body 58, and a cable coupling portion 66 extended toward the left side from a lower end portion of the lever main body 58.

Circular shaped through holes 68, 70 are respectively formed in the outside projection 60 and the cable coupling portion 66. One-end portions of respective tension coil springs 72, 74 are anchored to these through holes 68, 70. The other-end portion of the tension coil spring 72 is anchored to an upper end portion (a first lateral extension portion 36B, described later) of the wire member 36, and the other-end portion of the tension coil spring 74 is anchored to a lower end portion of the wire member 36 (a second lateral extension portion 36G, described later). The lever bracket 56 is accordingly resiliently supported by the wire member 36 through the tension coil springs 72, 74.

A lower end portion of the lock coupling portion 62 of the lever bracket 56 is indirectly engaged with the latch 55 of the lock main body 52. Configuration is such that the latch 55 of the lock main body 52 rotates upward when the lever bracket 56 is displaced upward, so as to release engagement between the latch 55 of the lock main body 52 and the vehicle body side striker.

A one-end portion of an inner wire 80 of a remote cable 76 is coupled to a leading end portion of the cable coupling portion 66 of the lever bracket 56. A one-end portion of the outer casing 78 of the remote cable 76 is arranged above the cable coupling portion 66 and is fixed to a cable fixing bracket 38. The cable fixing bracket 38 is fixed to the right side frame section 24 through the lock bracket 30. The remote cable 76 is, as illustrated in FIG. 2, routed through below the frame 18 to the rear side of the seatback 14R. Configuration is such that the lever bracket 56 is displaced upward when an other-end portion of the inner wire 80 of the remote cable 76 is pull-operated.

A one-end portion of the strap 82 is coupled to the strap coupling portion 64 of the lever bracket 56. The strap 82 is, for example, configured from an elongated strip shaped material made from synthetic fibers or the like, and exhibits flexibility. The other-end side of the strap 82 is inserted through a non-illustrated strap pull-out opening formed in the base 42 of the seatbelt guide 40, and is pulled toward the upper side of the seatback 14R. Configuration is such that the lever bracket 56 is displaced upward when the other-end side of the strap 82 is pull-operated upward by an occupant.

As described above, the latch 55 of the lock main body 52 is rotated upward with respect to the housing 54 when the lever bracket 56 is displaced upward, in a configuration such that the engagement between the latch 55 of the lock main body 52 and the vehicle body side striker is released.

The protection frame 32 includes, as stated previously, the attachment bracket 34, the wire member 36, and the plate member 37. As illustrated in FIG. 4 to FIG. 9, the attachment bracket 34 is, for example, configured from a press-formed metal plate blank and is arranged at a right side of the lock main body 52 orientated with its thickness direction along the left-right direction. The attachment bracket 34 is fixed to the lock bracket 30 by fastening using bolts 31.

As illustrated in FIG. 3 to FIG. 8, FIG. 10, and FIG. 11, the wire member 36 is, for example, configured by bend-processed metal wire material formed in a substantially rectangular frame shape having a length along the height direction as viewed along the front-rear direction. The wire member 36 is fixed to the right side frame section 24, which is a right side portion of the frame 18 of the seatback 14R, through the attachment bracket 34, the lock main body 52, and the lock bracket 30.

The wire member 36 is configured from a first fixing portion 36A extending diagonally forward and upward from an upper portion of the attachment bracket 34, the first lateral extension portion 36B extending toward the left side from an upper end portion of the first fixing portion 36A, a first vertical extension portion 36C extending diagonally downward and forward from a left end portion of the first lateral extension portion 36B, an inclined portion 36D extending diagonally toward the left side and downward from a lower end portion of the first vertical extension portion 36C, a second vertical extension portion 36E extending diagonally downward and forward from a lower end portion of the inclined portion 36D, a rear extension portion 36F extending diagonally rearward and downward from a lower end portion of the second vertical extension portion 36E, the second lateral extension portion 36G extending toward the right side from a rear end portion of the rear extension portion 36F, and a second fixed portion 36H extending diagonally upward and rearward from a right end portion of the second lateral extension portion 36G.

The first fixing portion 36A is superimposed on an upper portion of the attachment bracket 34 from the right side, and is fixed to the upper portion of the attachment bracket 34 by a means such as welding or the like. The second fixed portion 36H is superimposed on a lower portion of the attachment bracket 34 from the right side, and is fixed to the lower portion of the attachment bracket 34 by a means such as welding or the like. The first lateral extension portion 36B is arranged separated from the lock main body 52 and the lever bracket 56 at the front side and upper side thereof. The first vertical extension portion 36C, the inclined portion 36D, the second vertical extension portion 36E, and the rear extension portion 36F are arranged separated to the front side and the left side with respect to the lock main body 52 and the lever bracket 56. The second lateral extension portion 36G is arranged separated from the lock main body 52 and the lever bracket 56 at the front side and lower side thereof.

As illustrated in FIG. 2 to FIG. 7, FIG. 12, and FIG. 13, the plate member 37 is, for example, configured from a press-formed metal plate blank, and is formed in a substantially rectangular plate shape having a length along the height direction as viewed along the front-rear direction. The first lateral extension portion 36B, the first vertical extension portion 36C, the inclined portion 36D, the second vertical extension portion 36E, the rear extension portion 36F, and the second lateral extension portion 36G of the wire member 36 are in contact with the rear face of the plate member 37. The wire member 36 is fixed to the plate member 37 by a means such as welding or the like. Plural through holes (reference numeral omitted) are formed in the plate member 37. An outside edge of the plate member 37 is bend and folded toward the rear side. The front face of the plate member 37 contacts the pad of the seatback 14R.

As illustrated in FIG. 2 to FIG. 6, the protection frame 32 configured as described above covers the lock main body 52, the lever bracket 56, the one-end portion of the outer casing 78, and the one-end portion of the inner wire 80, from the front side. The cable fixing bracket 38, to which the one-end portion of the outer casing 78 is fixed, is arranged facing the first vertical extension portion 36C and the inclined portion 36D of the wire member 36 from the rear side. The cable fixing bracket 38 corresponds to an “abutting member” of the present disclosure.

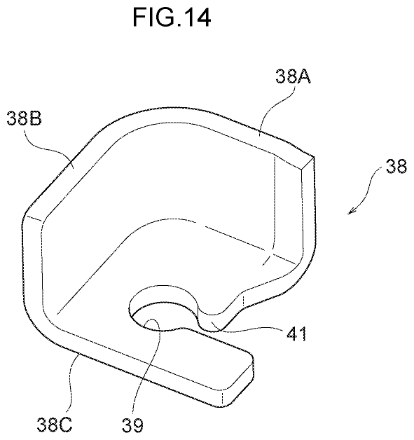

As illustrated in FIG. 14, the cable fixing bracket 38 is, for example, integrally configured from a press-formed metal plate blank including a bracket fixing portion 38A having a plate thickness direction substantially along the front-rear direction, a side wall portion 38B having a plate thickness direction substantially along the left-right direction, and a cable anchor portion 38C having a plate thickness direction substantially along the height direction. The bracket fixing portion 38A extends integrally upward from a rear edge of the cable anchor portion 38C, and the side wall portion 38B extends integrally upward from a left edge of the cable anchor portion 38C. A right edge of the bracket fixing portion 38A and a rear edge of the side wall 36B are integrally joined together.

The bracket fixing portion 38A is fixed to the lock bracket 30 by a means such as welding or the like, and the lock bracket 30 is fixed to the right side frame section 24 (namely, a right-side section of the frame 18) through the lock bracket 30. A through hole 39 into which the one-end portion of the outer casing 78 is inserted, and a cutout 41 through which the inner wire 80 passes, are formed to the cable anchor portion 38C. The cable fixing bracket 38 has an L-shaped cross-section open toward the left side (seat width direction inner side) and the upper side when viewed from the front. This cross-section is configured by the cable anchor portion 38C and the side wall portion 38B. A gap G1 is provided between the cable fixing bracket 38 and the protection frame 32, as illustrated in FIG. 6.

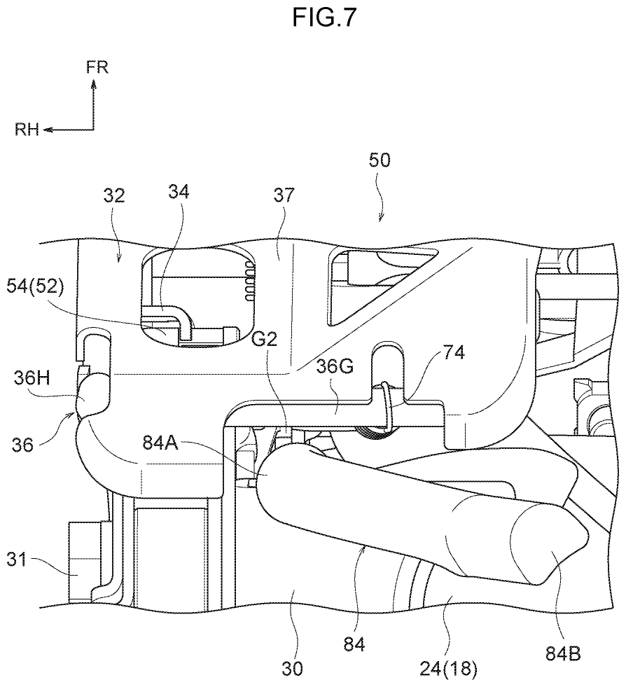

Separately from the cable fixing bracket 38, an abutting wire 84 fixed to the right side frame section 24 is arranged below the cable fixing bracket 38. The abutting wire 84 is, for example, formed in a bent rod shape that is formed in a substantially crank shape by bend-processing and press-processing a metal wire material. The abutting wire 84 is arranged with its length direction substantially along the height direction. A lower portion 84B of the abutting wire 84 is superimposed on a front face of the right side frame section 24, and is fixed to the right side frame section 24 by a means such as welding or the like. An upper portion 84A of the abutting wire 84 is arranged at a separation to the right side and the front side of the right side frame section 24, and is arranged facing the second lateral extension portion 36G of the wire member 36 from the rear side. A gap G2 is provided between the upper portion 84A of the abutting wire 84 and the second lateral extension portion 36G, as illustrated in FIG. 7.

In the vehicle seat 10 of the above configuration, the back of an occupant seated on the seat cushion 12 is supported by the seatback 14R. The seatback 14R is coupled so as to be swingable with respect to the vehicle body. The lock main body 52 of the lock device 50 is provided at a side section of the seatback 14R. Swinging of the seatback 14R is restricted by the latch 55 provided at the lock main body 52 being engaged with the striker provided at the vehicle body side portion. The lever bracket 56 arranged at the left side with respect to the lock main body 52 is indirectly engaged with the latch 55.

The strap 82 and the inner wire 80 of the remote cable 76 are coupled to the lever bracket 56. The strap 82 displaces the lever bracket 56 upward by being pulled. The remote cable 76 displaces the lever bracket 56 upward due to the inner wire 80 being pulled by remote operation while the one-end portion of the outer casing 78 is being supported by the side portion of the frame. In this manner, the lever bracket 56 is displaced upward, and the engagement between the latch 55 and the striker is released. This thereby enables the seatback 14R to be tilted forward onto the seat cushion 12.

The lever bracket 56 is covered from the front side by the protection frame 32. This means that the lever bracket 56 can be prevented from being lifted up unintentionally by external input being imparted from the front side through the pad of the seatback 14R such as, for example, when luggage in the luggage space collides with the back face of the seatback 14R due to a vehicle head-on collision, during a vehicle rear-end collision, or the like. As a result thereof, unwanted release of the locking of the lock main body 52 can be prevented from occurring.

Moreover, the protection frame 32 includes the wire member 36 fixed to a right side portion of the frame 18, and the plate member 37 fixed to the wire member 36. The plate member 37 has a function to protect the lever bracket 56 from external input imparted from the back face of the pad of the seatback 14R, and the wire member 36 has a function to support the plate member 37. This thereby enables the unwanted release of locking of the lock main body 52 to be effectively prevented from occurring.

Note that although, for example, employing a wire member bend-processed into a zig-zag shape might be considered instead of the plate member 37, this would lead to a possibility that the lever bracket 56 was lifted up unintentionally were the pad of the seatback 14R to intrude to the lever bracket 56 side through gaps in the zig-zag shaped wire member due to external input from the front side as described above. Regarding this point, the intrusion of the pad as described above can be avoided with the plate member 37. Moreover, a simpler and lighter configuration can be achieved with the plate member 37 than with such a zig-zag shaped wire member.

Moreover, in the present exemplary embodiment, the cable fixing bracket 38 fixed to a right side portion of the frame 18 of the seatback 14R faces the protection frame 32 from the rear side. This means that the protection frame 32 abuts against the cable fixing bracket 38 when an external input has been imparted to the protection frame 32 from the front side during a vehicle collision, enabling the protection frame 32 to be supported by the cable fixing bracket 38. As a result thereof, deformation of the protection frame 32 can be suppressed from occurring, and so the unwanted release of the locking of the lock main body 52 can be even more effectively prevented from occurring.

Moreover, in the present exemplary embodiment, the cable fixing bracket 38, to which the one-end portion of the outer casing 78 has been fixed, also serves as an abutting member to abut the protection frame 32, thereby enabling the configuration to be simplified. Furthermore, the cable fixing bracket 38 has an L-shaped cross-section open toward the left side and the upper side when viewed from the front. This enables good strength of the cable fixing bracket 38 to be secured against external input from the front side.

Moreover, in the present exemplary embodiment, the abutting wire 84 that is fixed to the right side portion of the frame 18 separately from the cable fixing bracket 38 also faces the protection frame 32 from the rear side. This means that due to the protection frame 32 abutting the cable fixing bracket 38 and the abutting wire 84 when external input from the front side has been imparted to the protection frame 32 during a vehicle collision, the protection frame 32 can be supported by both the cable fixing bracket 38 and the abutting wire 84. As a result thereof, deformation of the protection frame 32 can be suppressed, enabling the unwanted release of the locking of the lock main body 52 to be even more effectively prevented from occurring.

Moreover, in the present exemplary embodiment, the gap G1 is provided between the protection frame 32 and the cable fixing bracket 38, and the gap G2 is provided between the protection frame 32 and the abutting wire 84. This thereby enables the generation of abnormal noises from unwanted contact of the protection frame 32 with the cable fixing bracket 38 and the abutting wire 84 to be prevented from occurring.

Note that although in the above exemplary embodiment a case has been described in which the vehicle seat 10 is configured with a right-side section and a left-right direction central section of a three-person rear seat, there is no limitation thereto. In cases in which the vehicle seat 10 according to the present disclosure is configured by a left-side section and a left-right direction central section of a three-person rear seat, the configuration is left-right symmetrical to the exemplary embodiment described above. Moreover, the seatback of the vehicle seat according to the present disclosure is not limited to being a dividable seat.

Moreover, although in the above exemplary embodiment a case has been described in which the present disclosure is applied to the vehicle seat 10, there is no limitation thereto, and the present disclosure is applicable to a transportation seat other than in a vehicle (such as in an aircraft or a ship).

In addition thereto, various other modifications may be implemented for the present disclosure within a range not departing from the spirit thereof. Moreover, obviously the scope of rights of the present disclosure is not limited to the above exemplary embodiment.

What is claimed is:

1. A seatback lock device comprising:
a lock main body that is coupled to a side portion of a frame of a seatback, so as to be tiltable in a forward direction with respect to a floor section of a vehicle body, and that engages with a striker provided at a side portion of the vehicle body;
a lever that is arranged at a seat width direction inner side with respect to the lock main body and coupled to the lock main body, and that releases engagement between the lock main body and the striker by being displaced toward a seat upper side;
a strap that is coupled to the lever and that displaces the lever toward the seat upper side by being pulled;
a remote cable having a one-end portion of an outer casing thereof fixed to the side portion of the frame, and having an inner wire extending from the one-end portion coupled to the lever, the remote cable displacing the lever toward the seat upper side due to the inner wire being pulled; and
a protection member that includes a wire member fixed to the side portion of the frame and a plate member fixed to the wire member, and that covers the lever from a seat front side.

2. The seatback lock device of claim 1, further comprising an abutting member that is fixed to the side portion of the frame and faces the protection member from a seat rear side.

3. The seatback lock device of claim 2, wherein the abutting member is a cable fixing bracket to which the one-end portion of the outer casing has been fixed.

4. The seatback lock device of claim 3, wherein the cable fixing bracket has an L-shaped cross-section open toward the seat width direction inner side and the seat upper side when viewed from the seat front side.

5. The seatback lock device of claim 2, further comprising an abutting wire that is fixed to the side portion of the frame separately from the abutting member, and that faces the protection member from the seat rear side.

6. The seatback lock device of claim 2, wherein a gap is provided between the protection member and the abutting member.

7. The seatback lock device of claim 5, wherein a gap is provided between the protection member and the abutting wire.

8. A vehicle seat comprising:
a seat cushion for an occupant of a vehicle to sit on;
a seatback that is coupled so as to be swingable with respect to a vehicle body and that supports a back of the occupant; and
the seatback lock device of claim 1, wherein the lock main body is provided at a side portion of the seatback, and the strap has been inserted into a strap pull-out opening formed in a shoulder of the seatback.
